(19) United States
(12) Patent Application Publication
(10) Pub. No.: US 2026/0017122 A1
(43) Pub. Date: Jan. 15, 2026

(54) COMPUTING POWER LOAD BALANCING METHOD AND APPARATUS

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/880,843

(22) PCT Filed: Jul. 5, 2022
(86) PCT No.: PCT/CN2022/103999

§ 371 Date: Jan. 3, 2025

(51) Int. Cl. G06F 9/50

(52) U.S. Cl. CPC G06F 9/5094; G06F 9/505; G06F 2209/508

(57) ABSTRACT

A computing power load balancing method includes: obtaining a load and a weight of a computing power node, and loads and weights of associated computing power nodes of the computing power node; determining a load adjustment amount of the computing power node and load adjustment amounts of the associated computing power nodes based on the load and the weight of the computing power node and the loads and the weights of the associated computing power nodes; and adjusting the load of the computing power node based on the load adjustment amount of the computing power node and the load adjustment amounts of the associated computing power nodes.

### CROSS-REFERENCE TO RELATED APPLICATIONS

The present application is a National Stage of International Application No. PCT/CN2022/103999, filed Jul. 5, 2022, the entire disclosures of which are incorporated herein by reference for all purposes.

### FIELD

The present disclosure relates to the field of communication technology, in particular to a computing power load balancing method and a computing power load balancing apparatus.

### BACKGROUND

Along with the development of the network technology, a network may include open computing power, i.e., a technical capability of the network is open to be used by a user. The network may include a plurality of servers for providing computing power, and these servers may provide the computing power for the users of the whole network. However, in a case that a plurality of servers provides the computing power for a plurality of users, such a problem as unbalanced computing power load occurs for the plurality of servers.

### SUMMARY

According to embodiments of a first aspect of the present disclosure, a computing power load balancing method, applied to a computing power node in a computing power network, is provided. The computing power load balancing method includes: obtaining a load and a weight of the computing power node, and loads and weights of associated computing power nodes of the computing power node; determining a load adjustment amount of the computing power node and load adjustment amounts of the associated computing power nodes based on the load and the weight of the computing power node and the loads and the weights of the associated computing power nodes; and adjusting the load of the computing power node based on the load adjustment amount of the computing power node and the load adjustment amounts of the associated computing power nodes.

According to embodiments of a second aspect of the present disclosure, a communication apparatus is provided. The communication apparatus includes a processor, and the processor is configured to call a computer program in the memory to implement the computing power load balancing method in the first aspect.

According to embodiments of a third aspect of the present disclosure, a communication apparatus is provided. The communication apparatus includes a processor and a memory, the memory is configured to store therein a computer program, and the processor is configured to execute the computer program in the memory to implement the computing power load balancing method in embodiments of the first aspect.

According to embodiments of a fourth aspect of the present disclosure, another communication apparatus is provided. The communication apparatus includes a processor and an interface circuit, the interface circuit is configured to receive a code instruction and transmit the code instruction to the processor, and the processor is configured to execute the code instruction to implement the computing power load balancing method in the first aspect.

According to embodiments of a fifth aspect of the present disclosure, a computing power load balancing system is provided. The computing power load balancing system includes the communication apparatus in embodiments of the second aspect, or includes the communication apparatus in embodiments of the third aspect, or includes the communication apparatus in the fourth aspect, or includes the communication apparatus in the fifth aspect.

According to embodiments of a sixth aspect of the present disclosure, a computer-readable storage medium is provided. The computer-readable storage medium has stored therein an instruction to be used by the above communication apparatus, and in a case of the instruction is executed, the communication apparatus executes the computing power load balancing method in embodiments of the first aspect.

According to embodiments of a seventh aspect of the present disclosure, a computer program product including a computing program is further provided. In a case that the computer program is executed by a computer, the computer executes the computing power load balancing method in embodiments of the first aspect.

According to embodiments of an eighth aspect of the present disclosure, a chip system is provided. The chip system includes at least one processor and an interface, and is configured to support a communication device to achieve functions involved in the first aspect, e.g., determining or processing at least one of data or information involved in the above method. In a possible design, the chip system further includes a memory configured to store therein a computer program and data desired for the network device. The chip system includes a chip, or includes a chip and other discrete elements.

According to embodiments of a ninth aspect of the present disclosure, a computer program is further provided. In a case that the computer program is executed by a computer, the computer executes the computing power load balancing method in embodiments of the first aspect.

### BRIEF DESCRIPTION OF THE DRAWINGS

In order to illustrate the technical solutions of the embodiments of the present disclosure or the background in a clearer manner, the drawings desired for the embodiments of the present disclosure or the background will be described hereinafter briefly.

FIG. 1 is a schematic diagram of a communication apparatus according to some embodiments of the present disclosure;

FIG. 2 is a flowchart of a computing power load balancing method according to some embodiments of the present disclosure;

FIG. 3 is another flowchart of the computing power load balancing method according to some embodiments of the present disclosure;

FIG. 4 is yet another flowchart of the computing power load balancing method according to some embodiments of the present disclosure;

FIG. 5 is still yet another flowchart of the computing power load balancing method according to some embodiments of the present disclosure;

FIG. 6 is still yet another flowchart of the computing power load balancing method according to some embodiments of the present disclosure;

FIG. 7 is a block diagram of a communication apparatus according to some embodiments of the present disclosure;

FIG. 8 is another block diagram of the communication apparatus according to some embodiments of the present disclosure; and

FIG. 9 is a block diagram of a chip according to some embodiments of the present disclosure.

### DETAILED DESCRIPTION

In order to understand a computing power load balancing method in the embodiments of the present disclosure in a better manner, an applicable communication system will be described hereinafter at first.

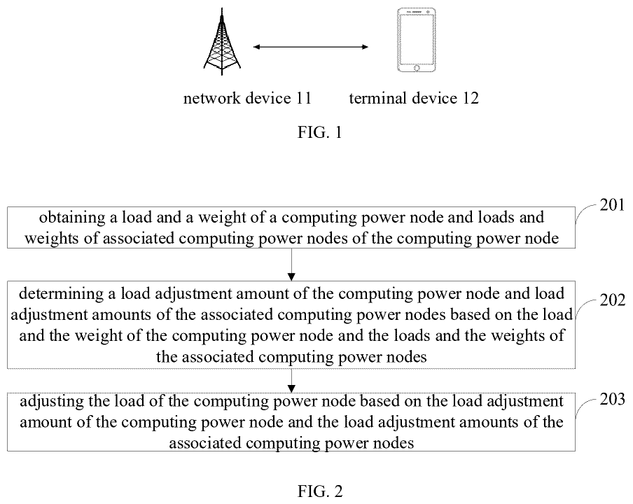

Referring to FIG. 1 which is a schematic diagram of a communication system according to some embodiments of the present disclosure, the communication system includes, but is not limited to, one network device and one terminal device. Quantities and forms of the devices in FIG. 1 are for illustrative purposes only, but shall not be construed as limiting the embodiments of the present disclosure. In actual use, the communication system may include two or more network devices and two or more terminal devices. In the communication system as shown in FIG. 1, one network device 11 and one terminal device 12 are taken as an example.

It should be appreciated that, the technical solutions in the embodiments of the present disclosure may be applied to various communication systems, e.g., a Long Term Evolution (LTE) system, a 5th-Generation (5G) mobile communication system, a 5G New Radio (NR) system, or any novel mobile communication system that may occur in the future.

In the embodiments of the present disclosure, the network device 11 is an entity at a network side for sending or receiving a signal. For example, the network device 11 is an evolved NodeB (eNB), a Transmission Reception Point (TRP), a next generation NodeB (gNB) in the NR system, a base station in the future mobile communication system, or an access point in a Wireless Fidelity (WiFi) system. A specific technology adopted by the network device and a specific device form thereof will not be particularly defined herein. The network device in the embodiments of the present disclosure may consist of a Central Unit (CU) and a Distributed Unit (DU), and the CU may also be called as control unit. Through the CU-DU structure, a protocol layer for the network device, e.g., a base station, is divided, i.e., a part of functions of the protocol layer are centrally controlled by the CU, a part of, or all of, the remaining functions of the protocol layer are distributed in the DU, and the DU is controlled by the CU.

In the embodiments of the present disclosure, the terminal device 12 is an entity at a user side for receiving or sending a signal, e.g., a mobile phone. The terminal device may also be called as terminal, User Equipment (UE), Mobile Station (MS), Mobile Terminal (MT), etc. The terminal device may be a vehicle having a communication function, a smart vehicle, a mobile phone, a wearable device, a pad, a computer having a wireless transceiver function, a Virtual Reality (VR) terminal device, an Augmented Reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. In the embodiments of the present disclosure, a specific technology adopted by the terminal device and a specific device form thereof will not be particularly defined.

It should be appreciated that, the communication system described herein is used to describe the technical solutions provided in the embodiments of the present disclosure in a clearer manner, but shall not be construed as limiting the technical solutions. It is obvious for a person skilled in the art that, along with the evolution of the system architecture as well as the emergence of new service scenarios, the technical solutions are also applicable to similar technical problems.

Along with the development of the network technology, a network may include open computing power, i.e., a technical capability of the network is open to be used by a user. The network may include a plurality of servers for providing computing power, and these servers may provide the computing power for the users of the whole network. For example, a terminal device sends a computing request to a computing power server, and the computing power server obtains the computing request of the terminal device and provides the computing power for the terminal device. However, in a case that a plurality of servers provides the computing power for a plurality of users, such a problem as unbalanced computing power load occurs for the plurality of servers.

In addition, there are many computing power servers (i.e., computing power nodes) in the computing power network, and with the elapse of time, the quantity of computing power nodes may increase or decrease, i.e., the computing power nodes change dynamically. Moreover, for an object (e.g., terminal device) served by the computing power network, the use of the computing power also changes dynamically. Hence, computing power loads of the computing power nodes need to be adjusted dynamically to ensure dynamic balancing of the computing power loads.

In the present disclosure, the computing power node in the computing power network determines a load adjustment amount of the computing power node and load adjustment amounts of associated computing power nodes based on a load and a weight of the computing power node and loads and weights of the associated computing power nodes, and adjusts the load of the computing power node based on the load adjustment amount of the computing power node and the load adjustment amounts of the associated computing power nodes, so that load balancing is achieved between the computing power node and the associated computing power nodes. In this way, it is able to ensure the dynamic balancing of the loads of all the computing power nodes in the entire computing power network.

A computing power load balancing method and a computing power load balancing apparatus provided in the present disclosure will be described hereinafter in details in conjunction with the drawings.

Referring to FIG. 2 which is a flowchart of a computing power load balancing method according to some embodiments of the present disclosure, the method is executed by a computing power node in a computing power network. As shown in FIG. 2, the method includes, but is not limited to, the following steps.

Step 201: a load and a weight of the computing power node and loads and weights of associated computing power nodes of the computing power node are obtained.

In the present disclosure, each computing power node in the computing power network is provided with a corresponding associated computing power node, and the quantity of associated computing power nodes of each computing power node may be one or more, which will not be particularly defined herein.

In the present disclosure, the load of the computing power node and the associated computing power nodes of the computing power node may be configured in a case that the computing power node joins the computing power network. For example, in a case that a computing power node a(i) joins the computing power network, n associated computing power nodes, i.e., a(i+1), a(i+2), . . . , and a(i+n), as well as a weight, may be configured for the computing power node a(i), where n is a positive integer.

In the present disclosure, the associated computing power nodes of any computing power node in the computing power network may be existing computing power nodes in the computing power network, or computing power nodes joining the computing power network at the same time as the computing power node, which will not be particularly defined herein. In addition, the quantity of associated computing power nodes of each computing power node in the computing power network may be the same or different, which will not be particularly defined herein.

In the present disclosure, the weights of the associated computing power nodes may be configured in a case that the associated computing power nodes join the computing power network.

In the present disclosure, the weight is used to represent a computing capability of the computing power node. In a case that the computing power node has a larger weight, it may be considered that the computing capability of the computing power node is stronger, and more computing tasks may be undertaken by the computing power node, i.e., the load to be undertaken by the computing power node is larger. The weights of the computing power nodes in the computing power network may be the same or different, which will not be particularly defined herein.

In the present disclosure, the load may be represented by the quantity of uncompleted computing tasks, or represented by computing power required for the uncompleted computing tasks, which will not be particularly defined herein.

In the present disclosure, the associated computing power node may send its load and weight to the computing power node at a predetermined time interval so that the computing power node obtains the load and the weight of the associated computing power node, or the computing power node may inquire the load and the weight of the associated computing power node, which will not be particularly defined herein.

Step 202: a load adjustment amount of the computing power node and load adjustment amounts of the associated computing power nodes are determined based on the load and the weight of the computing power node and the loads and the weights of the associated computing power nodes.

The weight is used to represent the computing capability of the computing power node, so the loads to be undertaken by the computing power nodes are different in a case of different weights. Hence, the computing power node in the present disclosure may determine the load adjustment amount of the computing power node itself and the load adjustment amounts of the associated computing power nodes based on the load and the weight of the computing power node and the loads and the weights of the associated computing power nodes. The load adjustment amount is used to represent a load to be increased or decreased.

For example, associated computing power nodes of a computing power node a(i) are a(i+1), a(i+2), . . . , and a(i+n), a load of the computing power node a(i) is P(i), a weight of the computing power node is r(i), loads of a(i+1), a(i+2), . . . , and a(i+n) are P(i+1), P(i+2), . . . , and P(i+n) respectively, and weights of the associated computing power nodes are r(i+1), r(i+2), . . . , and r(i+n) respectively, so the computing power node a(i) may determine a load adjustment amount of the computing power node a(i) and load adjustment amounts of the associated computing power nodes a(i+1), a(i+2), . . . , and a(i+n) based on the load P(i) and weight r(i) of the computing power node a(i) and the loads P(i+1), P(i+2), . . . , and P(i+n) and the weights r(i+1), r(i+2), . . . , and r(i+n) of the associated computing power nodes.

In the present disclosure, a load to be undertaken by the computing power node and loads to be undertaken by the associated computing power nodes are determined based on the load and the weight of the computing power node and the loads and the weights of the associated computing power nodes, and then the load adjustment amount of the computing power node and the load adjustment amounts of the associated computing power nodes are determined in conjunction with the load of the computing power node and the loads of the associated computing power nodes.

Step 203: the load of the computing power node is adjusted based on the load adjustment amount of the computing power node and the load adjustment amounts of the associated computing power nodes.

In the present disclosure, whether the load of the computing power node needs to be decreased or increased or the load of the computing power node does not need to be adjusted may be determined based on the load adjustment amount of the computing power node. In a case that the load of the computing power node needs to be decreased, a part of the load of the computing power node may be adjusted to some associated computing power nodes based on the load adjustment amounts of the associated computing power nodes. In a case that the load of the computing power node needs to be increased, a part of the loads of some associated computing power nodes may be adjusted to the computing power node based on the load adjustment amounts of the associated computing power nodes. In this way, it is able to achieve the balance between the load of the computing power node and the loads of the associated computing power nodes.

In the present disclosure, each computing power node in the computing power network may determine the load adjustment amount of the computing power node and the load adjustment amounts of the associated computing power nodes based on its load and weight and the loads and weights of the associated computing power nodes, and adjust its load based on the load adjustment amount of the computing power node and the load adjustment amounts of the associated computing power nodes, so that load balancing is achieved between the computing power node and the associated computing power nodes. In this way, it is able to ensure the dynamic balancing of the loads of all the computing power nodes in the entire computing power network.

For example, in a case that associated computing power nodes of a computing power node a(i) are a(i+1), a(i+2), . . . , and a(i+n), the computing power node a(i) may adjust its load using the above-mentioned computing power load balancing method. The associated computing power node a(i+1) also has its own associated computing power nodes, and it may also adjust its load using the above-mentioned computing power load balancing method. The associated computing power node a(i+2) also has its own associated computing power nodes, and it may also adjust its load using the above-mentioned computing power load balancing method. Hence, each computing power node in the computing power network may achieve the load balancing with its associated computing power nodes, so as to ensure the dynamic balancing of the loads of all computing power nodes in the entire computing power network.

In the embodiments of the present disclosure, the computing power node in the computing power network determines the load adjustment amount of the computing power node and the load adjustment amounts the associated computing power nodes based on the load and the weight of the computing power node and the loads and the weights of the associated computing power nodes, and adjusts the load of the computing power node based on the load adjustment amount of the computing power node and the load adjustment amounts of the associated computing power nodes, so that load balancing is achieved between the computing power node and the associated computing power nodes. In this way, it is able to ensure the dynamic balancing of the loads of all the computing power nodes in the entire computing power network.

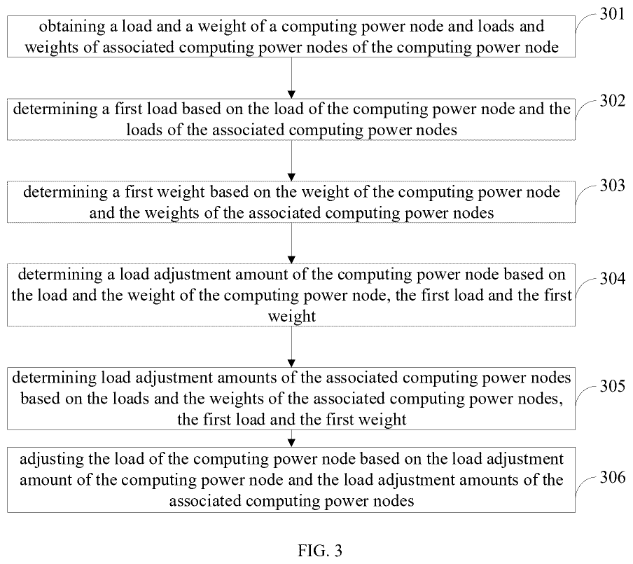

Referring to FIG. 3 which is a flowchart of another computing power load balancing method according to some embodiments of the present disclosure, the method is executed by a computing power node in a computing power network. As shown in FIG. 3, the method includes, but is not limited to, the following steps.

Step 301: a load and a weight of the computing power node and loads and weights of associated computing power nodes of the computing power node are obtained.

In some embodiments of the present disclosure, Step 301 may be implemented using any method in the embodiments of the present disclosure, which will not be particularly defined herein.

Step 302: a first load is determined based on the load of the computing power node and the loads of the associated computing power nodes.

In the present disclosure, a sum of the load of the computing power node and the loads of the associated computing power nodes is determined as the first load.

Step 303: a first weight is determined based on the weight of the computing power node and the weights of the associated computing power nodes.

In the present disclosure, a sum of the weight of the computing power node and the weights of the associated computing power nodes is determined as the first weight.

Step 304: a load adjustment amount of the computing power node is determined based on the load and the weight of the computing power node, the first load and the first weight.

In the present disclosure, a proportion of the weight of the computing power node in the first weight is determined based on the weight of the computing power node and the first weight, i.e., a first ratio of the weight of the computing power node to the first weight is determined, and a load to be undertaken by the computing power node is determined based on the first ratio and the first load in a case that the load balancing needs to be achieved between the computing power node and the associated computing power node, and then the load adjustment amount of the computing power node is determined based on the load to be undertaken by the computing power node and a current load of the computing power node.

In a case of determining the load adjustment amount of the computing power node, the current load of the computing power node is subtracted from the load to be undertaken by the computing power node, and a difference thereof is taken as the load adjustment amount of the computing power node. Alternatively, the load to be undertaken by the computing power node is subtracted from the current load of the computing power node, and a difference thereof is taken as the load adjustment amount of the computing power node.

Step 305: load adjustment amounts of the associated computing power nodes are determined based on the loads and weights of the associated computing power nodes, the first load and the first weight.

In the present disclosure, a proportion of the weight of each associated computing power node in the first weight is determined based on the weight of the associated computing power node and the first weight, i.e., a second ratio of the weight of the associated computing power node to the first weight is determined, and a load to be undertaken by the associated computing power node is determined based on the second ratio and the first load in a case that the load balancing needs to be achieved between the computing power node and the associated computing power node, and then the load adjustment amount of the associated computing power node is determined based on the load to be undertaken by the associated computing power node and a current load of the associated computing power node.

In a case of determining the load adjustment amount of the associated computing power node, the current load of the associated computing power node is subtracted from the load to be undertaken by the associated computing power node, and a difference thereof is taken as the load adjustment amount of the associated computing power node. Alternatively, the load to be undertaken by the associated computing power node is subtracted from the current load of the associated computing power node, and a difference thereof is taken as the load adjustment amount of the associated computing power node.

For example, associated computing power nodes of a computing power node a(i) are a(i+1), a(i+2), . . . , and a(i+n), a load of the computing power node a(i) is P(i), a weight of the computing power node a(i) is r(i), loads of a(i+1), a(i+2), . . . , and a(i+n) are P(i+1), P(i+2), . . . , and P(i+n) respectively, and weights of the associate computing power nodes are r(i+1), r(i+2), . . . , and r(i+n), where n is a positive integer. A load adjustment amount of the computing power node a(i) may be calculated through the following formula (1), and a load adjustment amount of the associate computing power node may be calculated through the following formula (2):

$$Δ P ( i ) = \frac{r ( i )}{r ( i ) + r ( i + 1 ) + r ( i + 2 ) + L + r ( i + n )} * [ P ( i ) + P ( i + 1 ) + P ( i + 2 ) L + P ( i + n ) ] - P ( i ) \qquad ( 1 )$$

$$Δ P ( i + m ) = \frac{r ( i + m )}{r ( i ) + r ( i + 1 ) + r ( i + 2 ) + L + r ( i + n )} * [ P ( i ) + P ( i + 1 ) + P ( i + 2 ) L + P ( i + n ) ] - P ( i + m ) \qquad ( 2 )$$

where ΔP(i) represents the load adjustment amount of the computing power node a(i), ΔP(i+m) represents the load adjustment amount of the associated computing power node a(i+1), P(i+m) represents a load of an associated computing power node a(i+m), and m=1, 2, . . . , n.

Step 306: the load of the computing power node is adjusted based on the load adjustment amount of the computing power node and the load adjustment amounts of the associated computing power nodes.

In the embodiments of the present disclosure, Step 306 may be implemented using any method in the embodiments of the present disclosure, which will not be particularly defined herein.

In the embodiments of the present disclosure, each computing power node in the computing power network determines the first load based on its load and the loads of the associated computing power nodes, determines the first weight based on its weight and the weights of the associated computing power nodes, determines its load adjustment amount based on its load and weight, the first load and the first weight, determines the load adjustment amounts of the associated computing power nodes based on the loads and weights of the associated computing power nodes, the first load and the first weight, and adjusts its load based on its load adjustment amount and the load adjustment amounts of the associated computing power nodes. In this way, it is able to ensure the dynamic balancing of the loads of all the computing power nodes in the entire computing power network.

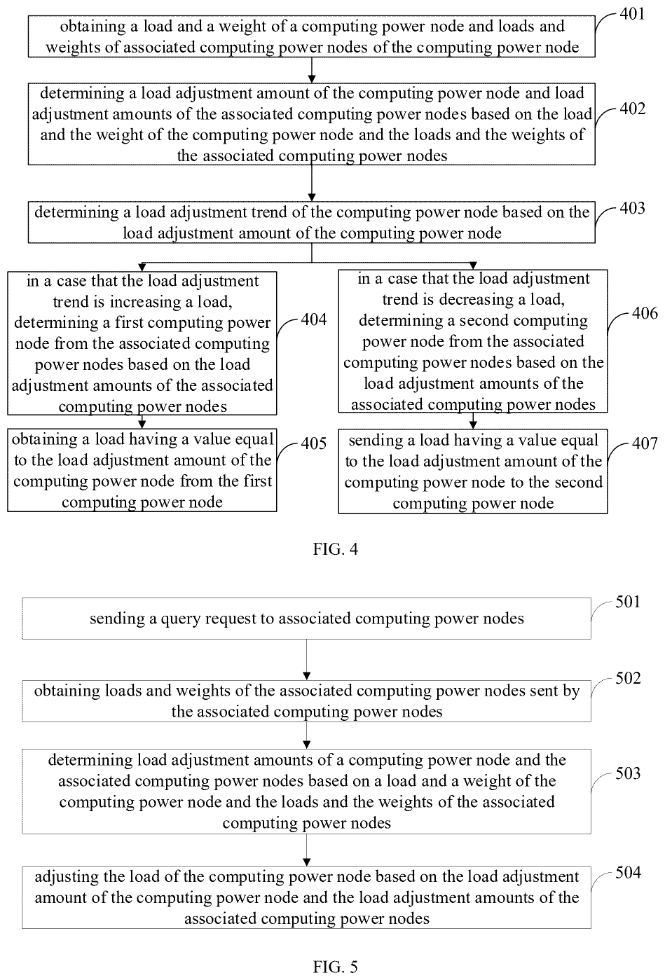

Referring to FIG. 4 which is a flowchart of another computing power load balancing method according to some embodiments of the present disclosure, the method is executed by a computing power node in a computing power network. As shown in FIG. 4, the method includes, but is not limited to, the following steps.

Step 401: a load and a weight of the computing power node and loads and weights of associated computing power nodes of the computing power node are obtained.

Step 402: a load adjustment amount of the computing power node and load adjustment amounts of the associated computing power nodes are determined based on the load and the weight of the computing power node and the loads and the weights of the associated computing power nodes.

In some embodiments of the present disclosure, Steps 401 and 402 may be implemented using any method in the embodiments of the present disclosure, which will not be particularly defined herein.

Step 403: a load adjustment trend of the computing power node is determined based on the load adjustment amount of the computing power node.

In the present disclosure, the load adjustment trend of the computing power node may be determined based on whether the load adjustment amount of the computing power node is greater than or smaller than zero. During the calculation of the load adjustment amount of the computing power node, if the load adjustment amount of the computing power node is obtained through subtracting a current load of the computing power node from a load to be undertaken by the computing power node in a case that the load balancing needs to be achieved between the computing power node and the associated computing power nodes, in a case that the load adjustment amount of the computing power node is greater than zero, it may be considered that the load adjustment trend of the computing power node is increasing a load; in a case that the load adjustment amount of the computing power node is smaller than zero, it may be considered that the load adjustment trend of the computing power node is decreasing a load; and in a case that the load adjustment amount of the computing power node is zero, it may be considered that the load of the computing power node does not need to be adjusted.

For example, a load adjustment amount of a computing power node a(i) is obtained through the above formula (1). If the load adjustment amount ΔP(i) of the computing power node a(i) is greater than zero, it means that a current load of the computing power node a(i) does not reach a load to be undertaken, and a load adjustment trend of the computing power node a(i) may be determined to be increasing the load. If the load adjustment amount ΔP(i) of the computing power node a(i) is smaller than zero, it means that the current load of the computing power node a(i) exceeds the load to be undertaken, and the load adjustment trend of the computing power node a(i) may be determined to be decreasing the load.

It should be appreciated that, if the load adjustment amount of the computing power node is obtained through subtracting the load to be undertaken by the computing power node from the current load of the computing power node, in a case that the load adjustment amount of the computing power node is greater than zero, the load adjustment trend of the computing power node may be determined to be decreasing the load; and in a case that the load adjustment amount of the computing power node is smaller than zero, the load adjustment trend of the computing power node may be determined to be increasing the load.

Step 404: in a case that the load adjustment trend is increasing the load, a first computing power node is determined from the associated computing power nodes based on the load adjustment amounts of the associated computing power nodes.

In the present disclosure, if the load adjustment trend of the computing power node is increasing the load, the load adjustment trends of the associated computing power nodes are determined based on the load adjustment amounts of the associated computing power nodes, the associated computing power nodes whose load adjustment trend is decreasing the load are determined, and then the first computing power node is determined from the associated computing power nodes whose load adjustment trend is decreasing the load based on the load adjustment amount of the computing power node and the load adjustment amounts of the associated computing power nodes whose load adjustment trend is decreasing the load. There may exist one or more first computing power nodes, which will not be particularly defined herein.

In the present disclosure, a method for determining the load adjustment trend of the associated computing power node is similar to a method for determining the load adjustment trend of the computing power node, and thus will not be particularly defined.

Step 405: a load having a value equal to the load adjustment amount of the computing power node is obtained from the first computing power node.

In the present disclosure, the computing power node may send a load obtaining request to the first computing power node, so as to obtain the load from the first computing power node. The load obtaining request includes a value of the to-be-obtained load.

For example, in a case that the load adjustment trend of the computing power node a(i) is increasing the load and the first computing power node corresponding to the computing power node a(i) is a(i+2), the computing power node a(i) may send the load obtaining request to the associated computing power node a(i+2), so as to obtain the load having a value equal to the load adjustment amount from the associated computing power node a(i+2).

In the present disclosure, in a case that there are multiple first computing power nodes, the loads are obtained from the multiple first computing power nodes, and a sum of the loads obtained from the first computing power nodes is equal to the load adjustment amount of the computing power node.

Step 406: in a case that the load adjustment trend is decreasing the load, a second computing power node is determined from the associated computing power nodes based on the load adjustment amounts of the associated computing power nodes.

In the present disclosure, in a case that the load adjustment trend of the computing power node includes decreasing the load, the load adjustment trend of the associated computing power node is determined based on the load adjustment amounts of the associated computing power nodes, the associated computing power nodes whose load adjustment trend is increasing the load are determined, and the second computing power node is determined from the associated computing power nodes whose load adjustment trend is increasing the load based on the load adjustment amount of the computing power node and the load adjustment amounts of the associated computing power nodes whose load adjustment trend is increasing the load. There may exist one or more second computing power nodes, which will not be particularly defined herein.

In the present disclosure, a method for determining the load adjustment trend of the associated computing power node is similar to a method for determining the load adjustment trend of the computing power node, and thus will not be particularly defined.

Step 407: a load having a value equal to the load adjustment amount of the computing power node is sent by the second computing power node.

In the present disclosure, the computing power node may send a load to the second computing power node. In a case that there is one second computing power node, the computing power node may transmit the load having a value equal to the load adjustment amount to the second computing power node, so that the load of the computing power node after the adjustment is the same as the load to be undertaken by the computing power node.

For example, in a case that a load adjustment trend of the computing power node a(i) includes decreasing a load and a second computing power node corresponding to the computing power node a(i) is a(i+3), the computing power node a(i) may send the load having a value equal to the load adjustment amount to the associated computing power node a(i+3), so that a load of the computing power node a(i) after the adjustment is the same as a load to be undertaken by the computing power node a(i).

In the present disclosure, in a case that there are multiple second computing power nodes, loads may be sent to the second computing power nodes, and a sum of the loads sent to the second computing power nodes is equal to the load adjustment amount of the computing power node.

In the embodiments of the present disclosure, in a case of adjusting the load of the computing power node, the load adjustment trend of the computing power node is determined based on the load adjustment amount of the computing power node, and the load of the computing power node is adjusted based on the load adjustment trend, so that the load of the computing power node after the adjustment is the same as the load to be undertaken, and the load balancing is achieved between the computing power node and the association computing power nodes. In this way, it is able to ensure the dynamic balancing of the loads of all the computing power nodes in the entire computing power network.

Referring to FIG. 5 which is a flowchart of another computing power load balancing method according to some embodiments of the present disclosure, and the method is executed by a computing power node in a computing power network. As shown in FIG. 5, the method includes, but is not limited to, the following steps.

Step 501: a query request is sent to associated computing power nodes.

In the present disclosure, in a case that the computing power node joins the computing power network and the associated computing power nodes are configured for the computing power nodes, such information as an identifier of each associated computing power node may be further configured to the computing power node, so that the computing power node has the information, e.g., the identifier of each associated computing power node. The computing power node may send the query request to the associated computing power nodes, and the query request is used to inquire loads and weights of the associated computing power nodes.

In the present disclosure, in a case that there are multiple associated computing power nodes of the computing power node, the query request may be sent to each associated computing power node.

Step 502: the loads and weights of the associated computing power nodes sent by the associated computing power nodes are obtained.

In the present disclosure, after obtaining the query request of the computing power node, the associated computing power nodes may send the loads and weights to the computing power node, so the computing power node may obtain the loads and weights of the associated computing power nodes.

Step 503: load adjustment amounts of the computing power node and the associated computing power nodes are determined based on a load and a weight of the computing power node and the loads and the weights of the associated computing power nodes.

Step 504: the load of the computing power node is adjusted based on the load adjustment amount of the computing power node and the load adjustment amounts of the associated computing power nodes.

In the present disclosure, Steps 503 and 504 may be implemented using any method in the embodiments of the present disclosure, which will not be particularly defined herein.

In the embodiments of the present disclosure, the computing power node sends the query request to the associated computing power nodes to obtain the loads and the weights of the associated computing power nodes, determines the load adjustment amounts of the computing power node and the associated computing power nodes based on the load and the weight of the computing power node and the loads and the weights of the associated computing power nodes, and adjusts the load of the computing power node based on the load adjustment amount of the computing power node and the load adjustment amounts of the associated computing power nodes, so that the load balancing is achieved between the computing power node and the associated computing power nodes. In this way, it is able to ensure the dynamic balancing of the loads of all the computing power nodes in the entire computing power network.

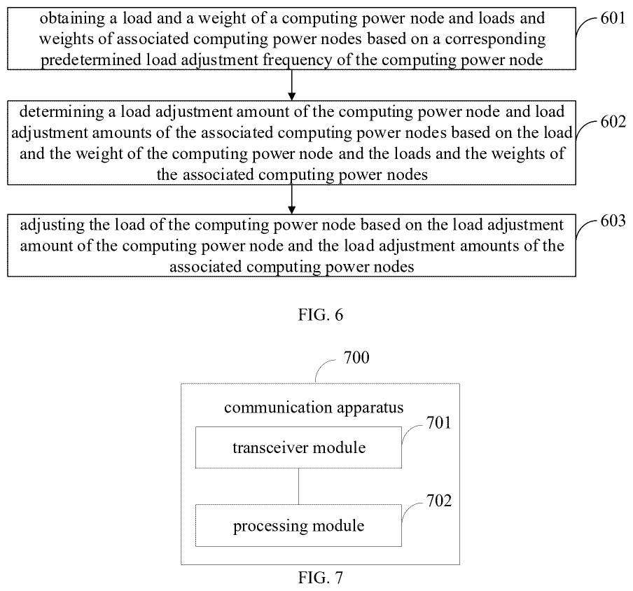

Referring to FIG. 6 which is a flowchart of another computing power load balancing method according to some embodiments of the present disclosure, the method is executed by a computing power node in a computing power network. As shown in FIG. 6, the method includes, but is not limited to, the following steps.

Step 601: a load and a weight of the computing power node and loads and weights of associated computing power nodes are obtained based on a corresponding predetermined load adjustment frequency of the computing power node.

In the present disclosure, the computing power nodes in the computing power network all have corresponding predetermined load adjustment frequencies, and each computing power node may obtain the load and weight of the computing power node and the loads and the weights of the associated computing power nodes based on the corresponding predetermined load adjustment frequency.

The corresponding load adjustment frequencies of different computing power nodes in the computing power network may be the same or different, which will not be particularly defined herein.

In the present disclosure, a method for obtaining the load and the weight of the computing power node and the loads and the weights of the associated computing power nodes may be implemented using any method in the embodiments of the present disclosure, and thus will not be particularly defined herein.

Step 602: a load adjustment amount of the computing power node and load adjustment amounts of the associated computing power nodes are determined based on the load and the weight of the computing power node and the loads and the weights of the associated computing power nodes.

Step 603: the load of the computing power node is adjusted based on the load adjustment amount of the computing power node and the load adjustment amounts of the associated computing power nodes.

In the present disclosure, Steps 602 and 603 may be implemented using any method in the embodiments of the present disclosure, which will not be particularly defined herein.

In the embodiments of the present disclosure, the load and weight of the computing power node and the loads and weighs of the associated computing power nodes are obtained based on the corresponding predetermined load adjustment frequency of the computing power node, the load adjustment amounts of the computing power node and the associated computing power nodes are determined based on the load and weight of the computing power node and the loads and weights of the associated computing power nodes, and the load of the computing power node is adjusted based on the load adjustment amount of the computing power node and the load adjustment amounts of the associated computing power nodes, so that each computing power node in the computing power network may adjust its load based on the corresponding load adjustment frequency, and the load balancing is achieved between each computing power node and its associated computing power nodes. In this way, it is able to ensure the dynamic balancing of the loads of all the computing power nodes in the entire computing power network.

Referring to FIG. 7 which is a block diagram of a communication apparatus 700 according to some embodiments of the present disclosure, the communication apparatus 700 includes a transceiver module 701 and a processing module 702. The transceiver module 701 includes a transmission module and/or a reception module, the transmission module is configured to achieve a transmission function, the reception module is configured to achieve a reception function, and the transceiver module 701 may achieve the transmission function and/or reception function.

The communication apparatus 700 may be a network device, or an apparatus in the network device, or an apparatus capable of being used in combination with the network device.

The communication apparatus 700 may include a transceiver module 701 and a processing module 702.

The transceiver module 701 is configured to obtain a load and a weight of a computing power node, and loads and weights of associated computing power nodes of the computing power node.

The processing module 702 is configured to determine a load adjustment amount of the computing power node and load adjustment amounts of the associated computing power nodes based on the load and the weight of the computing power node and the loads and the weights of the associated computing power nodes; and adjust the load of the computing power node based on the load adjustment amount of the computing power node and the load adjustment amounts of the associated computing power nodes.

Optionally, the processing module 702 is configured to: determine a first load based on the load of the computing power node and the loads of the associated computing power nodes; determine a first weight based on the weight of the computing power node and the weights of the associated computing power nodes; determine the load adjustment amount of the computing power node based on the load and the weight of the computing power node, the first load and the first weight; and determine the load adjustment amounts of the associated computing power nodes based on the loads and the weights of the associated computing power nodes, the first load and the first weight.

Optionally, the processing module 702 is configured to: determine a first ratio of the weight of the computing power node to the first weight; and determine the load adjustment amount of the computing power node based on the first ratio, the load of the computing power node and the first load.

Optionally, the processing module 702 is configured to: determine a second ratio of the weight of each of the associated computing power nodes to the first weight; and determine the load adjustment amount of each of the associated computing power nodes based on the second ratio, the load of the associated computing power node and the first load.

Optionally, the processing module 702 is configured to: determine a load adjustment trend of the computing power node based on the load adjustment amount of the computing power node; and in a case that the load adjustment trend is increasing a load, determine a first computing power node from the associated computing power nodes based on the load adjustment amounts of the associated computing power nodes. The transceiver module 701 is configured to obtain a load having a value equal to the load adjustment amount of the computing power node from the first computing power node. The processing module 702 is configured to, in a case that the load adjustment trend is decreasing a load, determine a second computing power node from the associated computing power nodes based on the load adjustment amounts of the associated computing power nodes. The transceiver module 701 is configured to send a load having a value equal to the load adjustment amount of the computing power node to the second computing power node.

Optionally, the transceiver module 701 is configured to: send a query request to the associated computing power nodes, in which the query request is used to inquire the loads and the weights of the associated computing power nodes; and obtain the loads and the weights of the associated computing power nodes sent by the associated computing power nodes.

Optionally, the transceiver module 701 is configured to: obtain the load and the weight of the computing power node and the loads and the weights of the associated computing power nodes based on a corresponding predetermined load adjustment frequency of the computing power node.

In the present disclosure, the load adjustment amounts of the computing power node and the associated computing power nodes are determined based on the load and the weight of the computing power node and the loads and the weights of the associated computing power nodes, and the load of the computing power node is adjusted based on the load adjustment amount of the computing power node and the load adjustment amounts of the associated computing power nodes, so that the load balancing is achieved between the computing power node and the associated computing power nodes. In this way, it is able to ensure the dynamic balancing of the loads of all the computing power nodes in the entire computing power network.

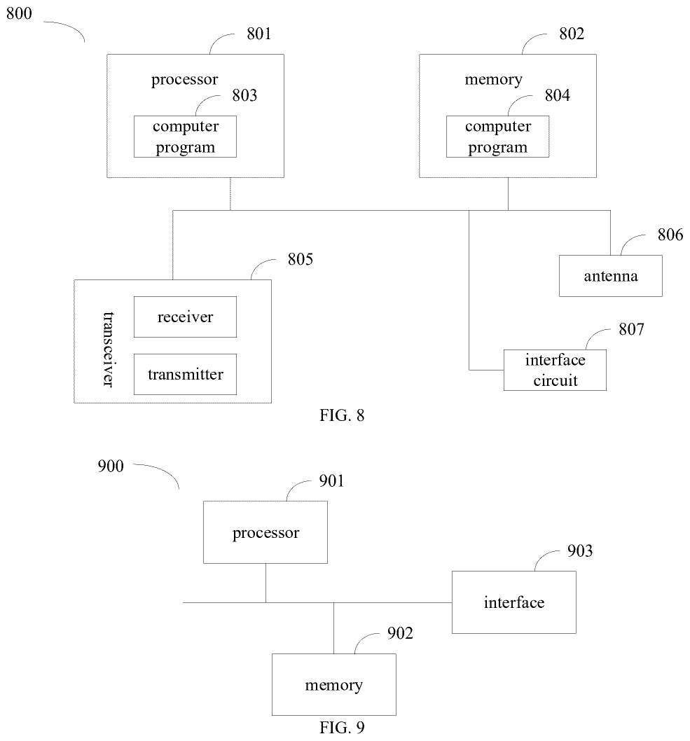

Referring to FIG. 8 which is a block diagram of another communication apparatus 800 according to some embodiments of the present disclosure, the communication apparatus 800 may be a network device, or a chip, a chip system or a processor which supports the network device to implement the above-mentioned method. The communication apparatus is used to implement the method described in the above method embodiment, and the implementation thereof may refer to that in the above method embodiment.

The communication apparatus 800 may include one or more processors 801. The processor 801 may be a general-purpose processor or special-purpose processor, e.g., a baseband processor or a central processing unit. The baseband processor is configured to process a communication protocol as well as communication data, and the central processing unit is configured to control the communication apparatus (e.g., a base station, a baseband chip, a terminal, a terminal device chip, a Distributed Unit (DU) or a Centralized Unit (CU)), execute a computer program, and process data in the computer program.

Optionally, the communication apparatus 800 further includes one or more memories 802 having stored therein a computer program 804. The computer program 804 is executed by the processor 801, so that the communication apparatus 800 executes the method in the above method embodiment. Optionally, the memory 802 may further have stored therein data. The communication apparatus 800 is arranged independent of, or integrated with, the memory 802.

Optionally, the communication apparatus 800 further includes a transceiver 805 and an antenna 806. The transceiver 805 is also called as a transceiver unit, a transceiver machine or a transceiver circuit, and it is configured to achieve a transmission function and a reception function. The transceiver 805 includes a receiver and a transmitter. The receiver is called as a receiving machine or a reception circuit, and it is configured to achieve the reception function. The transmitter is called as a transmitting machine or a transmission circuit, and it is configured to achieve the transmission function.

Optionally, the communication apparatus 800 further includes one or more interface circuits 807. The interface circuit 807 is configured to receive a code instruction and transmit it to the processor 801. The processor 801 executes the code instruction, so that the communication apparatus 800 implements the method described in the above method embodiment.

The processor 801 is configured to execute Steps 202 and 203 in FIG. 2, Steps 302 to 306 in FIG. 3, Steps 402 to 404 and 406 in FIG. 4, Steps 503 and 504 in FIG. 5, and Steps 602 and 603 in FIG. 6.

The transceiver 805 is configured to execute Step 201 in FIG. 2, Step 301 in FIG. 3, Steps 401, 405 and 407 in FIG. 4, Steps 501 and 502 in FIG. 5, and Step 601 in FIG. 6.

In one implementation, the processor 801 may include a transceiver for achieving a reception function and a transmission function. For example, the transceiver is a transceiver circuit, an interface, or an interface circuit. The transceiver circuit, the interface or the interface circuit for achieving the reception function and the transmission function may be arranged separately, or integrated with each other. The transceiver circuit, the interface or the interface circuit is configured to read and write codes/data, or transmit/or transfer signals.

In one implementation, the processor 801 stores therein a computer program 803, and the computer program 803 is executed by the processor 801, so that the communication apparatus 800 implements the method described in the above method embodiments. The computer program 803 may be programmed in the processor 801, and in this case, the processor 801 may be implemented through hardware.

In one implementation, the communication apparatus 800 includes a circuit for implementing the above-mentioned transmission, reception or communication function. The processor and the transceiver described in the embodiments of the present disclosure may be implemented in an Integrated Circuit (IC), an analog IC, a Radio Frequency IC (RFIC), a mixed-signal IC, an Application Specific Integrated Circuit (ASIC), a Printed Circuit Board (PCB) or an electronic device. The processor and the transceiver may also be manufactured through various IC processes, e.g., Complementary Metal Oxide Semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus mentioned hereinabove may be a network device or a terminal device, but the scope of the communication apparatus is not limited thereto. In addition, a structure of the communication apparatus is limited to that in FIG. 8. The communication apparatus may be an independent device, or a part of a large device. For example, the communication apparatus may be: (1) an independent IC, chip, chip system or chip sub-system; (2) a set of one or more ICs (optionally, the IC set also includes a memory member for storing therein data and a computer program; (3) an ASIC, e.g., a Modem; (4) a module capable of being embedded into the other device; (5) a receiver, a terminal device, a smart terminal device, a cellular phone, a wireless device, a handheld device, a mobile unit, a vehicle-mounted device, a network device, a cloud device, an artificial intelligence device, etc.; or (6) the other device.

In a case that the communication apparatus is a chip or a chip system, FIG. 9 is a schematic diagram of the chip according to some embodiments of the present disclosure. As shown in FIG. 9, the chip includes a processor 901 and an interface 903. There may exist one or more processors 901, and more than one interface 903.

The interface 903 is configured to execute Step 201 in FIG. 2, Step 301 in FIG. 3, Steps 401, 405 and 407 in FIG. 4, Steps 501 and 502 in FIG. 5, and Step 601 in FIG. 6.

Optionally, the chip further includes a memory 903 for storing therein necessary computer programs and data.

It should be appreciated that, various illustrative logical blocks and steps listed in the embodiments of the present disclosure may be implemented through electronic hardware, computer software, or a combination thereof. Whether these functions are implemented through hardware or software depends on design requirements on an entire system and specific applications. For each specific application, various methods are used to achieve the function, which however shall not be construed as going beyond the scope of the present disclosure.

The present disclosure further provides in some embodiments a readable storage medium having stored therein an instruction. When the instruction is executed by a computer, the functions in any of the above-mentioned method embodiments are achieved.

The present disclosure further provides in some embodiments a computer program product. The computer program product is executed by a computer so as to achieve the functions in any of the above-mentioned method embodiments.

In the above-mentioned embodiments of the present disclosure, all of, or a part of, the modules are implemented in the form of software, hardware, firmware or a combination thereof. When the modules are implemented in the form of software, all of, or a part of, the modules are implemented in the form of a computer program product. The computer program product includes one or more computer programs. When the computer programs are loaded onto and executed by a computer, all of, or a part of, the processes or functions in the embodiments of the present disclosure are generated by the computer. The computer may be a general-purpose computer, a special-purpose computer, a computer network, or any other programmable device. The computer program may be stored in a computer-readable storage medium, or transferred from one computer-readable storage medium to another computer-readable storage medium, e.g., transferred from one website, one computer, one server or one data center to another website, another computer, another server or another data center in a wired manner (e.g., through a co-axial cable, an optical fiber, or a digital subscriber line (DSL)) or a wireless manner (e.g., infrared, cordless or microwave). The computer-readable storage medium may be any available medium capable of being accessed by a computer, or a data storage device, e.g., a server or a data center including one or more available mediums. The available medium may be a magnetic medium (e.g., a floppy disc, a hard disc or magnetic tape), an optical medium (e.g., a digital video disc (DVD)), or a semiconductor medium (e.g., a solid state disk (SSD)).

It should be appreciated that, such words as “first” and “second” are used to differentiate the items from each other, but shall not be construed as limiting the scope of the present disclosure or indicating any sequence.

The expression “at least one” is used to indicate one or more, e.g., two, three, four or more, which will not be particularly defined herein. In the embodiments of the present disclosure, for technical features of a same kind, the words “first”, “second”, “third”, “A”, “B”, “C” and “D” are used to differentiate these technical features, without indicating any sequence or sizes thereof.

The correspondence shown in each table in the present disclosure may be configured or predefined. Values of information in each table are for illustrative purposes only, and any other values may also be configured, which will not be particularly defined herein. In a case of configuring the correspondence between the information and parameters, it is not necessary to configure all the correspondences in the table. For example, in the table in the embodiments of the present disclosure, correspondences shown in some rows may not be configured. For another example, appropriate deformation or adjustment may be performed based on the table, e.g., splitting or combination. A name of each parameter in each table may use the other name capable of being understood by the communication apparatus, and a value of the parameter or a presentation mode thereof may also use that capable of being understood by the communication apparatus. During the implementation of each table, the other data structure may also be used, e.g., array, queue, container, stack, linear table, pointer, linked list, tree, map, structure, class, heap, or hash table.

1. A computing power load balancing method, comprising:
obtaining a load and a weight of a computing power node in a computing power network, and loads and weights of associated computing power nodes of the computing power node;
determining a load adjustment amount of the computing power node and load adjustment amounts of the associated computing power nodes based on the load and the weight of the computing power node and the loads and the weights of the associated computing power nodes; and
adjusting the load of the computing power node based on the load adjustment amount of the computing power node and the load adjustment amounts of the associated computing power nodes.

2. The computing power load balancing method according to claim 1, wherein the determining the load adjustment amount of the computing power node and the load adjustment amounts of the associated computing power nodes based on the load and the weight of the computing power node and the loads and the weights of the associated computing power nodes comprises:
determining a first load based on the load of the computing power node and the loads of the associated computing power nodes;
determining a first weight based on the weight of the computing power node and the weights of the associated computing power nodes;
determining the load adjustment amount of the computing power node based on the load and the weight of the computing power node, the first load and the first weight; and
determining the load adjustment amounts of the associated computing power nodes based on the loads and the weights of the associated computing power nodes, the first load and the first weight.

3. The computing power load balancing method according to claim 2, wherein the determining the load adjustment amount of the computing power node based on the load and the weight of the computing power node, the first load and the first weight comprises:
determining a first ratio of the weight of the computing power node to the first weight; and
determining the load adjustment amount of the computing power node based on the first ratio, the load of the computing power node and the first load.

4. The computing power load balancing method according to claim 2, wherein the determining the load adjustment amounts of the associated computing power nodes based on the loads and the weights of the associated computing power nodes, the first load and the first weight comprises:
determining a second ratio of a weight of at least one of the associated computing power nodes to the first weight; and
determining a load adjustment amount of at least one of the associated computing power nodes based on the second ratio, a load of at least one of the associated computing power nodes and the first load.

5. The computing power load balancing method according to claim 1, wherein the adjusting the load of the computing power node based on the load adjustment amount of the computing power node and the load adjustment amounts of the associated computing power nodes comprises:
determining a load adjustment trend of the computing power node based on the load adjustment amount of the computing power node;
in a case that the load adjustment trend is increasing a load, determining a first computing power node from the associated computing power nodes based on the load adjustment amounts of the associated computing power nodes;
obtaining a load having a value equal to the load adjustment amount of the computing power node from the first computing power node;
in a case that the load adjustment trend is decreasing a load, determining a second computing power node from the associated computing power nodes based on the load adjustment amounts of the associated computing power nodes; and
sending a load having a value equal to the load adjustment amount of the computing power node to the second computing power node.

6. The computing power load balancing method according to claim 1, wherein the obtaining the loads and the weights of the associated computing power nodes of the computing power node comprises:
sending a query request to the associated computing power nodes, wherein the query request is configured to inquire the loads and the weights of the associated computing power nodes; and
obtaining the loads and the weights of the associated computing power nodes sent by the associated computing power nodes.

7. The computing power load balancing method according to claim 1, wherein the obtaining the load and the weight of the computing power node and the loads and the weights of the associated computing power nodes of the computing power node comprises:
obtaining the load and the weight of the computing power node and the loads and the weights of the associated computing power nodes based on a corresponding predetermined load adjustment frequency of the computing power node.

8-14. (canceled)

15. A communication apparatus, comprising a processor and a memory, wherein the memory is configured to store therein a computer program, and the processor is configured to execute the computer program in the memory to implement following operations:
obtaining a load and a weight of a computing power node, and loads and weights of associated computing power nodes of the computing power node;
determining a load adjustment amount of the computing power node and load adjustment amounts of the associated computing power nodes based on the load and the weight of the computing power node and the loads and the weights of the associated computing power nodes; and
adjusting the load of the computing power node based on the load adjustment amount of the computing power node and the load adjustment amounts of the associated computing power nodes.

16. A computer-readable storage medium having stored therein an instruction that, when executed, causes following operations to be implemented:
obtaining a load and a weight of a computing power node, and loads and weights of associated computing power nodes of the computing power node;
determining a load adjustment amount of the computing power node and load adjustment amounts of the associated computing power nodes based on the load and the weight of the computing power node and the loads and the weights of the associated computing power nodes; and
adjusting the load of the computing power node based on the load adjustment amount of the computing power node and the load adjustment amounts of the associated computing power nodes.

17. The communication apparatus according to claim 15, wherein the processor is further configured to:
determine a first load based on the load of the computing power node and the loads of the associated computing power nodes;
determine a first weight based on the weight of the computing power node and the weights of the associated computing power nodes;
determine the load adjustment amount of the computing power node based on the load and the weight of the computing power node, the first load and the first weight; and
determine the load adjustment amounts of the associated computing power nodes based on the loads and the weights of the associated computing power nodes, the first load and the first weight.

18. The communication apparatus according to claim 17, wherein the processor is further configured to:
determine a first ratio of the weight of the computing power node to the first weight; and
determine the load adjustment amount of the computing power node based on the first ratio, the load of the computing power node and the first load.

19. The communication apparatus according to claim 17, wherein the processor is further configured to:
determine a second ratio of a weight of at least one of the associated computing power nodes to the first weight; and
determine a load adjustment amount of at least one of the associated computing power nodes based on the second ratio, a load of at least one of the associated computing power nodes and the first load.

20. The communication apparatus according to claim 15, wherein the processor is further configured to:
determine a load adjustment trend of the computing power node based on the load adjustment amount of the computing power node;
in a case that the load adjustment trend is increasing a load, determine a first computing power node from the associated computing power nodes based on the load adjustment amounts of the associated computing power nodes;
obtain a load having a value equal to the load adjustment amount of the computing power node from the first computing power node;
in a case that the load adjustment trend is decreasing a load, determine a second computing power node from the associated computing power nodes based on the load adjustment amounts of the associated computing power nodes; and
send a load having a value equal to the load adjustment amount of the computing power node to the second computing power node.

21. The communication apparatus according to claim 15, wherein the processor is further configured to:
send a query request to the associated computing power nodes, wherein the query request is configured to inquire the loads and the weights of the associated computing power nodes; and
obtain the loads and the weights of the associated computing power nodes sent by the associated computing power nodes.

22. The communication apparatus according to claim 15, wherein the processor is further configured to:
obtain the load and the weight of the computing power node and the loads and the weights of the associated computing power nodes based on a corresponding predetermined load adjustment frequency of the computing power node.

23. The computer-readable storage medium according to claim 16, the determining the load adjustment amount of the computing power node and the load adjustment amounts of the associated computing power nodes based on the load and the weight of the computing power node and the loads and the weights of the associated computing power nodes comprises:
determining a first load based on the load of the computing power node and the loads of the associated computing power nodes;
determining a first weight based on the weight of the computing power node and the weights of the associated computing power nodes;
determining the load adjustment amount of the computing power node based on the load and the weight of the computing power node, the first load and the first weight; and
determining the load adjustment amounts of the associated computing power nodes based on the loads and the weights of the associated computing power nodes, the first load and the first weight.

24. The computer-readable storage medium according to claim 23, wherein the determining the load adjustment amount of the computing power node based on the load and the weight of the computing power node, the first load and the first weight comprises:
determining a first ratio of the weight of the computing power node to the first weight; and
determining the load adjustment amount of the computing power node based on the first ratio, the load of the computing power node and the first load.

25. The computer-readable storage medium according to claim 23, wherein the determining the load adjustment amounts of the associated computing power nodes based on the loads and the weights of the associated computing power nodes, the first load and the first weight comprises:
determining a second ratio of a weight of at least one of the associated computing power nodes to the first weight; and
determining a load adjustment amount of at least one of the associated computing power nodes based on the second ratio, the load of the associated computing power node and the first load.

26. The computer-readable storage medium according to claim 16, wherein the adjusting the load of the computing power node based on the load adjustment amount of the computing power node and the load adjustment amounts of the associated computing power nodes comprises:
determining a load adjustment trend of the computing power node based on the load adjustment amount of the computing power node;
in a case that the load adjustment trend is increasing a load, determining a first computing power node from the associated computing power nodes based on the load adjustment amounts of the associated computing power nodes;
obtaining a load having a value equal to the load adjustment amount of the computing power node from the first computing power node;
in a case that the load adjustment trend is decreasing a load, determining a second computing power node from the associated computing power nodes based on the load adjustment amounts of the associated computing power nodes; and
sending a load having a value equal to the load adjustment amount of the computing power node to the second computing power node.

27. The computer-readable storage medium according to claim 16, wherein the obtaining the loads and the weights of the associated computing power nodes of the computing power node comprises:
sending a query request to the associated computing power nodes, wherein the query request is configured to inquire the loads and the weights of the associated computing power nodes; and
obtaining the loads and the weights of the associated computing power nodes sent by the associated computing power nodes.
